(19) United States
(12) Patent Application Publication
(10) Pub. No.: US 2021/0341031 A1
(43) Pub. Date: Nov. 4, 2021

(54) SHOCK ABSORBING LATTICE STRUCTURE PRODUCED BY ADDITIVE MANUFACTURING

(71) Applicant: Carbon, Inc., Redwood City, CA (US)

(72) Inventors: Hardik Kabaria, San Francisco, CA (US); Aidan Kurtz, Palomar Park, CA (US)

(21) Appl. No.: 17/283,116

(22) PCT Filed: Oct. 17, 2019
(86) PCT No.: PCT/US2019/056697

§ 371 Date: Apr. 6, 2021

Related U.S. Application Data
(60) Provisional application No. 62/748,620, filed on Oct. 22, 2018.

(51) Int. Cl. F16F 7/12; B33Y 80/00

(52) U.S. Cl. CPC F16F 7/121; B33Y 10/00; B33Y 80/00

(57) ABSTRACT

An energy absorbing lattice structure having a predetermined energy absorbing load vector, may include, in combination, a first lattice substructure comprised of a first set of interconnected struts, and, interwoven with said first lattice substructure, a second lattice substructure comprised of a second set of interconnected struts.

### CROSS-REFERENCE TO RELATED APPLICATION

This application claims priority to U.S. Provisional Application Ser. No. 62/748,620, filed Oct. 22, 2018, the disclosure of which is hereby incorporated by reference in its entirety.

### FIELD OF THE INVENTION

The present invention concerns shock absorbing lattice structures useful in protective bumpers, pads, cushions, shock absorbers, and the like, that can be produced by additive manufacturing.

### BACKGROUND OF THE INVENTION

A group of additive manufacturing techniques sometimes referred to as “stereolithography” create a three-dimensional object by the sequential polymerization of a light polymerizable resin. Such techniques may be “bottom-up” techniques, where light is projected into the resin onto the bottom of the growing object through a light transmissive window, or “top down” techniques, where light is projected onto the resin on top of the growing object, which is then immersed downward into a pool of resin.

The recent introduction of a more rapid stereolithography technique sometimes referred to as continuous liquid interface production (CLIP) has expanded the usefulness of stereolithography from prototyping to manufacturing. See J. Tumbleston, D. Shirvanyants, N. Ermoshkin et al., Continuous liquid interface production of 3D objects, SCIENCE 347, 1349-1352 (published online 16 Mar. 2015); U.S. Pat. Nos. 9,211,678; 9,205,601; and U.S. Pat. No. 9,216,546 to DeSimone et al.; see also R. Janusziewicz, et al., Layerless fabrication with continuous liquid interface production, PNAS 113, 11703-11708 (18 Oct. 2016).

Dual cure resins for additive manufacturing were introduced shortly after the introduction of CLIP, expanding the usefulness of stereolithography for manufacturing a broad variety of objects still further. See Rolland et al., U.S. Pat. Nos. 9,676,963, 9,453,142 and 9,598,606; J. Poelma and J. Rolland, Rethinking digital manufacturing with polymers, SCIENCE 358, 1384-1385 (15 Dec. 2017).

There is great interest in developing improved shock absorbers, cushions and pads, such as for helmets and other protective devices. See, for example, U.S. Pat. Nos. 9,839,251; 9,820,524; 9,392,831; and 7,765,622. However, the utility of additive manufacturing for developing new and unique components for such protective devices has yet to be fully explored.

### SUMMARY OF THE INVENTION

Various embodiments described herein provide lattice structures produced by additive manufacturing having improved shock absorbing properties.

According to some embodiments described herein, an energy absorbing lattice structure having a predetermined energy absorbing load vector, may include, in combination, a first lattice substructure comprised of a first set of interconnected struts, and, interwoven with said first lattice substructure, a second lattice substructure comprised of a second set of interconnected struts.

In some embodiments, said first lattice substructure and said second lattice substructure are interconnected with one another.

In some embodiments, the energy absorbing lattice structure is produced by a process of additive manufacturing (e.g., selective laser sintering (SLS), fused deposition modeling (FDM), stereolithography (SLA), three-dimensional printing (3DP), or multijet modeling (MJM)).

In some embodiments, said first and second lattice substructures are formed from the same material (e.g., a polymer, metal, ceramic, or composite thereof).

In some embodiments, said lattice structure is rigid, flexible, or elastic.

In some embodiments, said first set of interconnected struts and said second set of interconnected struts differ in diameter from one another. Optionally, said first set of interconnected struts comprises struts of differing diameters. Optionally, said second set of interconnected struts comprises struts of differing diameters.

In some embodiments, a stiffness of said first lattice substructure is sufficiently different from a stiffness of said second lattice substructure along said load vector, so that buckling of said substructures under a load applied to said structure along said load vector occurs sequentially rather than concurrently, thereby enhancing the energy absorbing capacity of said structure.

In some embodiments, struts that are substantially perpendicular to said load vector are excluded from said second lattice substructure.

In some embodiments, said first and second lattice substructures are defined by a tetrahedral mesh (e.g., an A15, C15, or alpha space packing, etc.) or a hexahedral mesh.

In some embodiments, said first set of interconnected struts interconnect centroids of adjacent tetrahedra of said mesh to one another, and said second set of interconnected struts interconnect a centroid of each tetrahedra of said mesh to four vertices thereof.

In some embodiments, said first set of interconnected struts interconnect the centroid of each tetrahedra of said mesh to the four vertices thereof, and said second set of interconnected struts interconnect the four vertices of each said tetrahedra of said mesh to one another.

In some embodiments, said first set of interconnected struts interconnect the centroids of adjacent tetrahedra of said mesh to one another, and said second set of interconnected struts interconnect the four vertices of each said tetrahedra of said mesh to one another.

In some embodiments, the energy absorbing lattice structure includes at least a third lattice substructure, interwoven with said first and second lattice substructures, and optionally interconnected with one or both thereof.

According to some embodiments described herein, a shock absorber, cushion, or pad includes a lattice structure of the embodiments described herein.

According to some embodiments described herein, a wearable protective device includes a cushion or pad of the embodiments described herein (e.g., a shin guard, knee pad, elbow pad, sports brassiere, bicycling shorts, backpack strap, backpack back, neck brace, chest protector, protective vest, protective jackets, slacks, suits, overalls, jumpsuit, and protective slacks, etc.).

According to some embodiments described herein, a bed or seat includes a cushion or pad of the embodiments described herein.

According to some embodiments described herein, an automotive or aerospace panel, bumper, or component includes a shock absorber, cushion, or pad of the embodiments described herein.

According to some embodiments described herein, a method of forming an energy absorbing lattice includes providing a mesh comprising a plurality of polyhedra, forming a first lattice substructure comprising a first set of interconnected struts that are defined by the mesh, forming a second lattice substructure including a second set of interconnected struts that are defined by the mesh, wherein the second lattice substructure differs from the first lattice substructure, and generating a compound lattice structure by combining the first lattice substructure with the second lattice substructure.

In some embodiments, the energy absorbing lattice includes a predetermined energy absorbing load vector, and the method further includes removing one or more struts from the compound lattice structure that are substantially perpendicular to the predetermined energy absorbing load vector.

In some embodiments, the method further includes manufacturing the compound lattice structure using an additive manufacturing process.

In some embodiments, forming the first lattice substructure includes forming a dual substructure by connecting centroids of adjacent polyhedra of the mesh.

In some embodiments, forming the second lattice substructure includes forming a rhombile tessellation substructure by connecting a centroid of each polyhedron of the mesh to corners of the polyhedron.

In some embodiments, the first lattice substructure and the second lattice substructure are interconnected with one another.

In some embodiments, the first set of interconnected struts and said second set of interconnected struts differ in diameter from one another.

In some embodiments, the first set of interconnected struts includes struts of differing diameters.

In some embodiments, the second set of interconnected struts includes struts of differing diameters.

In some embodiments, the mesh includes a plurality of tetrahedra or a plurality of hexahedra.

In some embodiments, the mesh includes a plurality of tetrahedra configured in an A15, C15, or alpha space packing structure.

In some embodiments, the first set of interconnected struts interconnect centroids of adjacent tetrahedra of the mesh to one another, and the second set of interconnected struts interconnect a centroid of each tetrahedra of said mesh to four vertices thereof.

In some embodiments, the first set of interconnected struts interconnect the centroid of each tetrahedra of the mesh to the four vertices thereof, and the second set of interconnected struts interconnect the four vertices of each tetrahedra of the mesh to one another.

In some embodiments, the first set of interconnected struts interconnect the centroids of adjacent tetrahedra of the mesh to one another, and the second set of interconnected struts interconnect the four vertices of each tetrahedra of the mesh to one another.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1A schematically illustrates one embodiment of a method of the present invention.

FIG. 1B schematically illustrates one embodiment of an apparatus useful for carrying out a method of the invention.

FIG. 2 illustrates an example of a tetrahedral mesh, such as produced in step 102 of the method of FIG. 1A.

FIG. 3 illustrates an example of a first lattice substructure, such as produced in step 103 of the method of FIG. 1A.

FIG. 4 illustrates an example of a second lattice substructure, such as produced in step 104 of the method of FIG. 1A.

FIGS. 5A and 5B illustrate views of an example of an initial compound lattice structure, such as produced in step 105 of the method of FIG. 1A.

FIG. 6 illustrates an example of a final lattice structure, with certain struts removed, as may be produced in step 106 of the method of FIG. 1A, and as then may be produced as an actual object by additive manufacturing.

FIG. 7 provides a detailed comparative view of portions of the example lattice structures FIGS. 5A/5B and 6, showing more specifically struts removed in step 106 (white arrows).

FIG. 8 schematically illustrates the transition of a tetrahedral lattice unit cell to its dual, through a series of five intermediate lattice cells.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with and/or contacting the other element or intervening elements can also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature can have portions that overlap or underlie the adjacent feature.

Spatially relative terms, such as “under,” “below,” “lower,” “over,” “upper” and the like, may be used herein for ease of description to describe an element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus the exemplary term “under” can encompass both an orientation of over and under. The device may otherwise be oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only, unless specifically indicated otherwise.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer or section discussed herein could be termed a second element, component, region, layer or section without departing from the teachings of the present invention. The sequence of operations (or steps) is not limited to the order presented in the claims or figures unless specifically indicated otherwise.

1. Additive Manufacturing Methods, Apparatus and Resins.

Techniques for additive manufacturing are known. Suitable techniques include, but are not limited to, techniques such as selective laser sintering (SLS), fused deposition modeling (FDM), stereolithography (SLA), material jetting including three-dimensional printing (3DP) and multijet modeling (MJM) (MJM including Multi-Jet Fusion such as available from Hewlett Packard), and others. See, e.g., H. Bikas et al., Additive manufacturing methods and modelling approaches: a critical review, Int. J. Adv. Manuf. Technol. 83, 389-405 (2016).

Resins for additive manufacturing of polymer articles are known and described in, for example, DeSimone et al., U.S. Pat. Nos. 9,211,678; 9,205,601; and 9,216,546. Dual cure resins for additive manufacturing are known and described in, for example, Rolland et al., U.S. Pat. Nos. 9,676,963; 9,598,606; and 9,453,142. Non-limiting examples of dual cure resins include, but are not limited to, resins for producing objects comprised of polymers such as polyurethane, polyurea, and copolymers thereof; objects comprised of epoxy; objects comprised of cyanate ester, objects comprised of silicone, etc.

Stereolithography, including bottom-up and top-down techniques, are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety.

In some embodiments, the object is formed by continuous liquid interface production (CLIP). CLIP is known and described in, for example, PCT Application Nos. PCT/US2014/015486 (U.S. Pat. No. 9,211,678); PCT/US2014/015506 (U.S. Pat. No. 9,205,601), PCT/US2014/015497 (U.S. Pat. No. 9,216,546), and in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad Sci. USA 113, 11703-11708 (Oct. 18, 2016). In some embodiments, CLIP employs features of a bottom-up three-dimensional fabrication as described above, but the irradiating and/or said advancing steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially-cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. Other approaches for carrying out CLIP that can be used in the present invention and obviate the need for a semipermeable “window” or window structure include utilizing a liquid interface comprising an immiscible liquid (see L. Robeson et al., WO 2015/164234, published Oct. 29, 2015), generating oxygen as an inhibitor by electrolysis (see 1. Craven et al., WO 2016/133759, published Aug. 25, 2016), and incorporating magnetically positionable particles to which the photoactivator is coupled into the polymerizable liquid (see J. Rolland, WO 2016/145182, published Sep. 15, 2016).

Other examples of methods and apparatus for carrying out particular embodiments of CLIP include, but are not limited to: B. Feller, US Patent App. Pub. No. US 2018/0243976 (published Aug. 30, 2018); M. Panzer and J. Tumbleston, US Patent App Pub. No. US 2018/0126630 (published May 10, 2018); K. Willis and B. Adzima, US Patent App Pub. No. US 2018/0290374 (Oct. 11, 2018); Batchelder et al., Continuous liquid interface production system with viscosity pump, US Patent Application Pub. No. US 2017/0129169 (May 11, 2017); Sun and Lichkus, Three-dimensional fabricating system for rapidly producing objects, US Patent Application Pub. No. US 2016/0288376 (Oct. 6, 2016); Willis et al., 3d print adhesion reduction during cure process, US Patent Application Pub. No. US 2015/0360419 (Dec. 17, 2015); Lin et al., Intelligent 3d printing through optimization of 3d print parameters, US Patent Application Pub. No. US 2015/0331402 (Nov. 19, 2015); and D. Castanon, Stereolithography System, US Patent Application Pub. No. US 2017/0129167 (May 11, 2017).

After the object is formed, it is typically cleaned, and in some embodiments then further cured, preferably by baking (although further curing may in some embodiments be concurrent with the first cure, or may be by different mechanisms such as contacting to water, as described in U.S. Pat. No. 9,453,142 to Rolland et al.).

2. Systems and Apparatus.

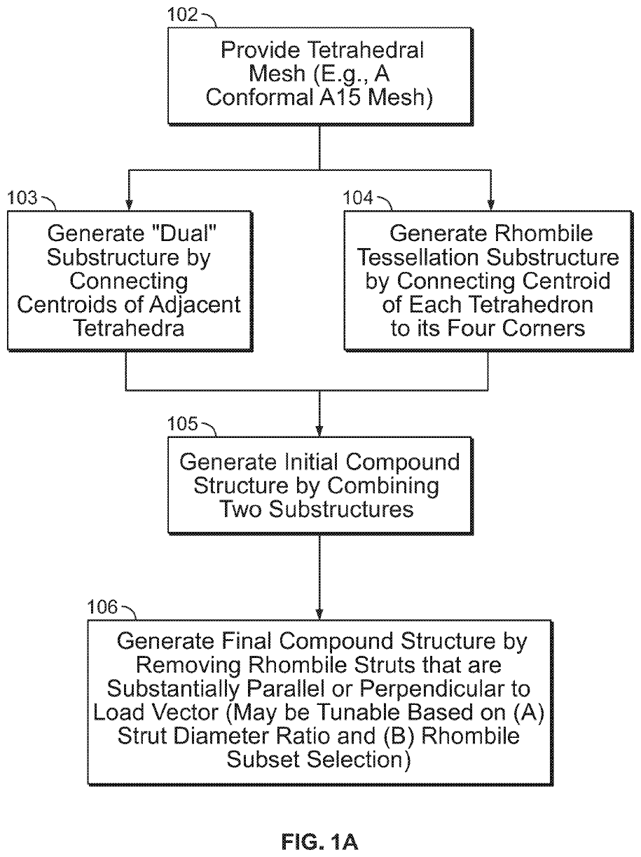

Methods and apparatus for carrying out the present invention are schematically illustrated in FIGS. 1A-1B. Such an apparatus includes a user interface 3 for inputting instructions (such as selection of an object to be produced, and selection of features to be added to the object), a controller 4, and a stereolithography apparatus 5 such as described above. An optional washer (not shown) can be included in the system if desired, or a separate washer can be utilized. Similarly, for dual cure resins, an oven (not shown) can be included in the system, although a separately-operated oven can also be utilized.

Connections between components of the system can be by any suitable configuration, including wired and/or wireless connections. The components may also communicate over one or more networks, including any conventional, public and/or private, real and/or virtual, wired and/or wireless network, including the Internet.

The controller 4 may be of any suitable type, such as a general-purpose computer. Typically the controller 4 will include at least one processor 4a, a volatile (or “working”) memory 4b, such as random-access memory, and at least one non-volatile or persistent memory 4c, such as a hard drive or a flash drive. The controller 4 may use hardware, software implemented with hardware, firmware, tangible computer-readable storage media having instructions stored thereon, and/or a combination thereof, and may be implemented in one or more computer systems or other processing systems. The controller 4 may also utilize a virtual instance of a computer. As such, the devices and methods described herein may be embodied in any combination of hardware and software that may all generally be referred to herein as a “circuit,” “module,” “component,” and/or “system.” Furthermore, aspects of the present invention may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one processor 4a of the controller 4 may be configured to execute computer program code for carrying out operations for aspects of the present invention, which computer program code may be written in any combination of one or more programming languages, including an object oriented programming language such as Java, Scala, Smalltalk, Eiffel, JADE, Emerald, C++, C#, VB.NET, or the like, conventional procedural programming languages, such as the “C” programming language, Visual Basic, Fortran 2003, COBOL 2002, PHP, ABAP, dynamic programming languages such as Python, PERL, Ruby, and Groovy, or other programming languages.

The at least one processor 4a may be, or may include, one or more programmable general purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices, which may be collocated or distributed across one or more data networks.

Connections between internal components of the controller 4 are shown only in part and connections between internal components of the controller 4 and external components are not shown for clarity, but are provided by additional components known in the art, such as busses, input/output boards, communication adapters, network adapters, etc. The connections between the internal components of the controller 4, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, an Advanced Technology Attachment (ATA) bus, a Serial ATA (SATA) bus, and/or an Institute of Electrical and Electronics Engineers (IEEE) standard 1394 bus, also called “Firewire.”

The user interface 3 may be of any suitable type. The user interface 3 may include a display and/or one or more user input devices. The display may be accessible to the at least one processor 4a via the connections between the system components. The display may provide graphical user interfaces for receiving input, displaying intermediate operation/data, and/or exporting output of the methods described herein. The display may include, but is not limited to, a monitor, a touch screen device, etc., including combinations thereof. The input device may include, but is not limited to, a mouse, keyboard, camera, etc., including combinations thereof. The input device may be accessible to the at least one processor 4a via the connections between the system components. The user interface 3 may interface with and/or be operated by computer readable software code instructions resident in the volatile memory 4b that are executed by the processor 4a.

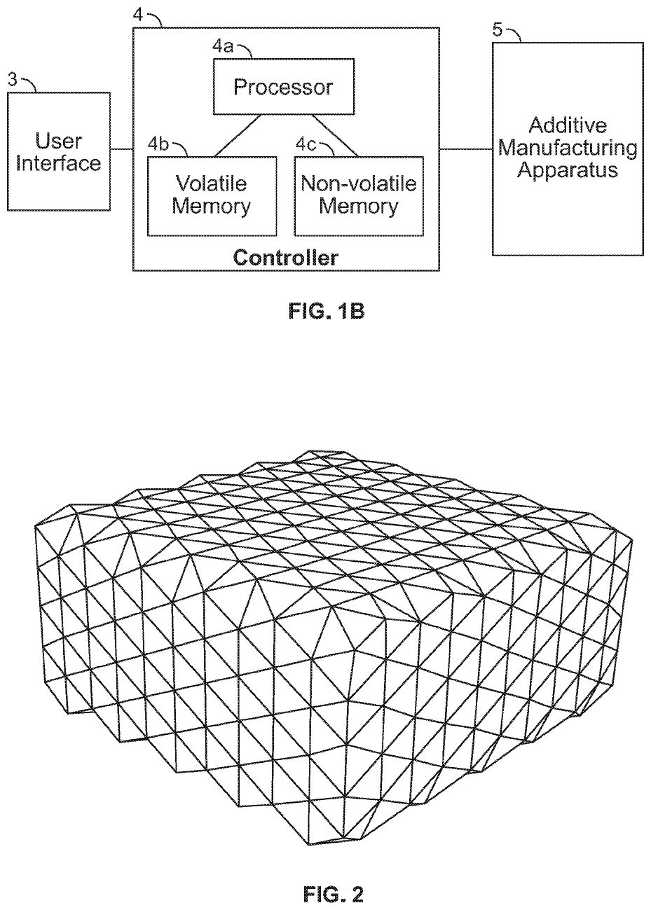

As illustrated in FIG. 1A, the controller 4 may be used to provide a mesh composed of a plurality of polyhedra (e.g., tetrahedra or hexahedra) in an operation 102 according to embodiments described herein. The mesh may be formed, for example, using the processor 4a and may be displayed, optionally, via user interface 3. In some embodiments, the mesh may be formed of a plurality of tetrahedra configured in a conformal A15, C15, or alpha space packing structure. The mesh may be a virtual mesh residing, for example, in the volatile memory 4b of the controller 4. FIG. 2 illustrates an example of a tetrahedral mesh, such as produced in operation 102 of the method of FIG. 1A.

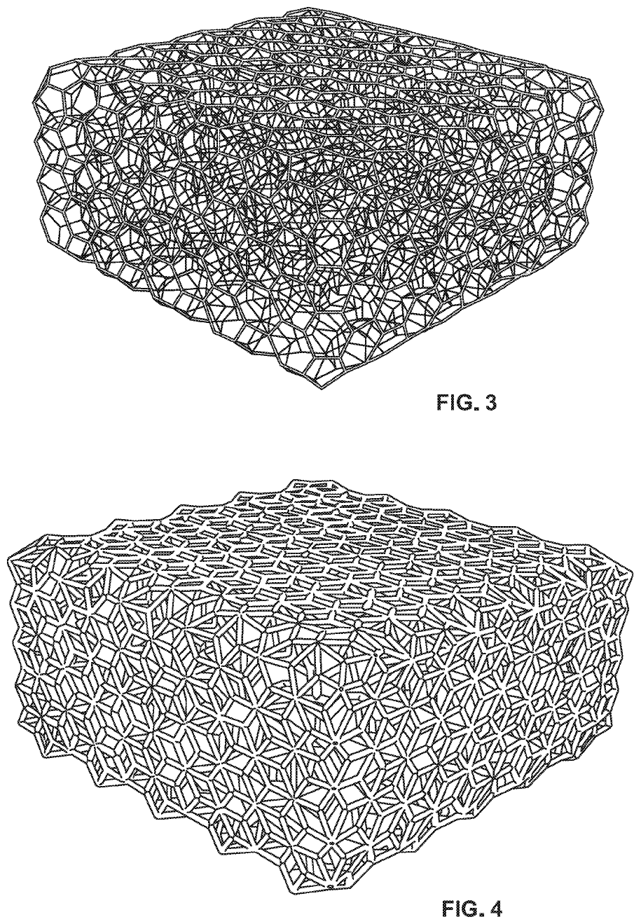

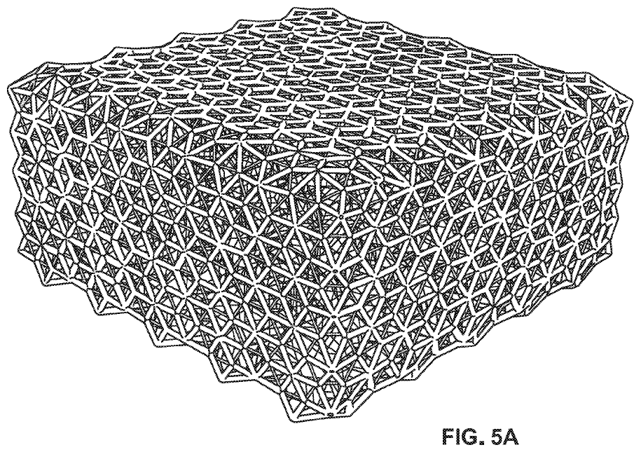

In operations 103 and 104 of the method of FIG. 1A, a first lattice substructure and a second lattice substructure may be generated. The first lattice substructure and the second lattice substructure may each be composed of a plurality of interconnected struts. In some embodiments, the various struts composing the first lattice substructure and/or the second lattice substructure may be of different diameters. For example, as illustrated in operation 103 of FIG. 1A, the first lattice substructure may be a dual substructure and, as illustrated in operation 104, the second lattice substructure may be a rhombile tessellation substructure. FIG. 3 illustrates the example of the first lattice substructure referenced in operation 103, and FIG. 4 illustrates the example of the second lattice substructure referenced in operation 104. The types of the first lattice substructure and the second lattice substructure may be defined based on the mesh provided in operation 102. In some embodiments, struts of the first lattice substructure and the second lattice substructure may be oriented relative to the centroid, vertices, and/or edges of the polyhedra of the provided mesh. Though FIG. 1A references a dual lattice substructure and a rhombile tessellation substructure, it will be understood that other types of lattice substructure utilizing different types of lattice cells may be used.

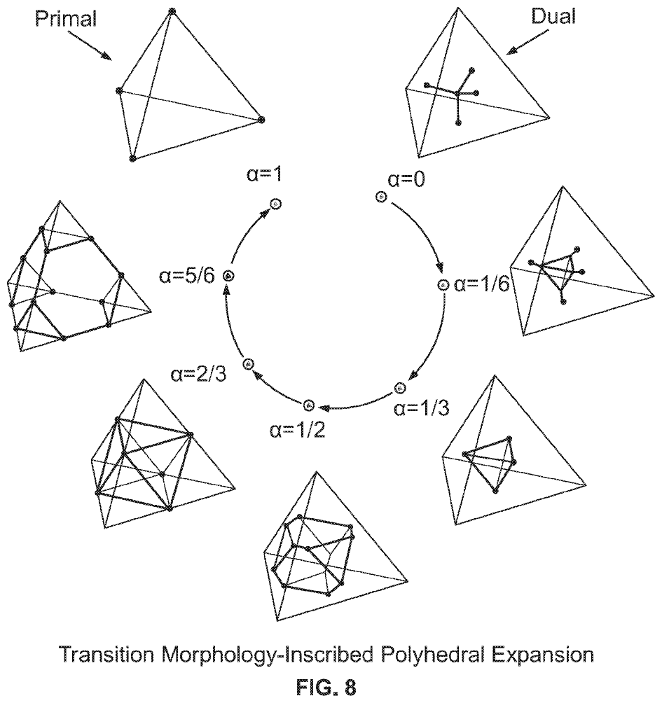

FIG. 8 is a non-limiting illustration of a variety of different lattice cells that can be defined by a tetrahedral mesh unit cell, ranging from the primal unit cell (where struts are aligned with edges and connected at corners, and struts along edges are shared by adjacent cells) to the corresponding dual (where centroids of adjacent cells are connected to one another by struts, and in the figure lines terminating as a point on each of the four faces of the tetrahedra represent struts projecting into, and connecting with the centroid of, adjacent tetrahedra). FIG. 8 illustrates a transition morphology of an inscribed polyhedral expansion. The group illustrated is not exhaustive: for example, the case where strut geometry is defined by centroids connecting corners is not shown, but can be included. In all the embodiments shown, heavy lines represent struts of a cell; struts along edges are shared by adjacent cells; and struts ending on a face of the tetrahedra interconnect with corresponding struts of adjacent cells. A composite lattice structure of the present invention can be assembled from two or more substructures, where each substructure is a mesh defined by the one of the unit cells shown or described (in the case of a cell defined by struts in which centroids connect corners).

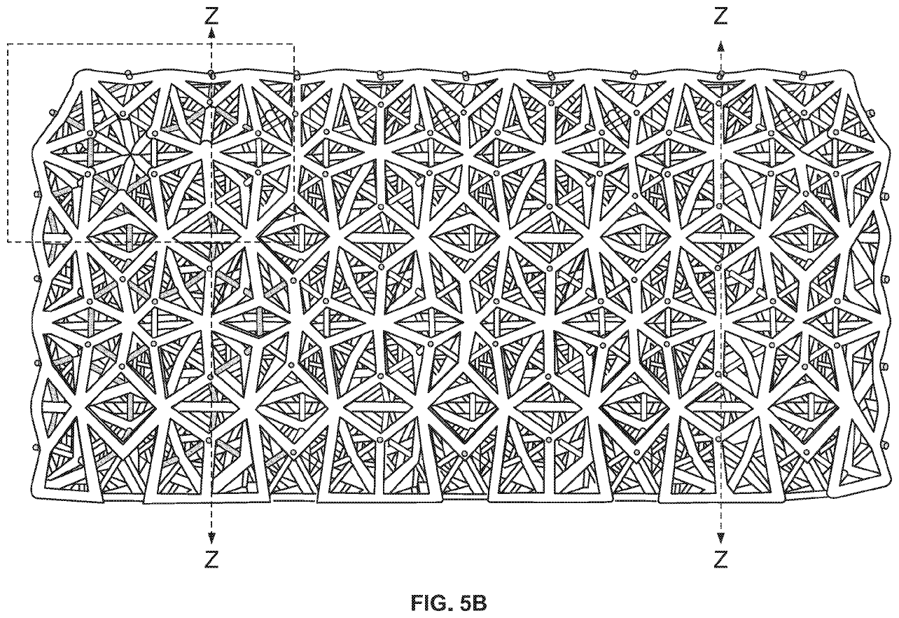

Referring back to FIG. 1A, in operation 105, an initial compound structure may be generated based on a combination of the first lattice substructure and the second lattice substructure. The combination may be generated, for example, using the processor 4a and may be displayed, optionally, via user interface 3. The combination of the first lattice substructure and the second lattice substructure may be generated by interweaving the first lattice substructure and the second lattice substructure together. In some embodiments, the first lattice substructure and the second lattice substructure may be interwoven by interconnecting the first lattice substructure and the second lattice substructure together, though the present embodiments are not limited thereto. In some embodiments, interweaving the first lattice substructure and the second lattice substructure is accomplished by generating a model of the first lattice substructure and the second lattice substructure in, for example, the non-volatile memory 4b of the controller 4, and forming the initial compound structure by manipulating the first and second lattice substructures to interweave them together. In some embodiments, portions of the first lattice substructure may surround and/or intersect portions of the second lattice substructure. In some embodiments, portions of the first lattice substructure may be within portions of the second lattice substructure. Thus, the initial compound structure may include portions of both the first lattice substructure and the second lattice substructure. FIG. 5A illustrates an example initial compound lattice structure as produced by operation 105. FIG. 5B illustrates a cross-section of the initial compound lattice structure of FIG. 5A.

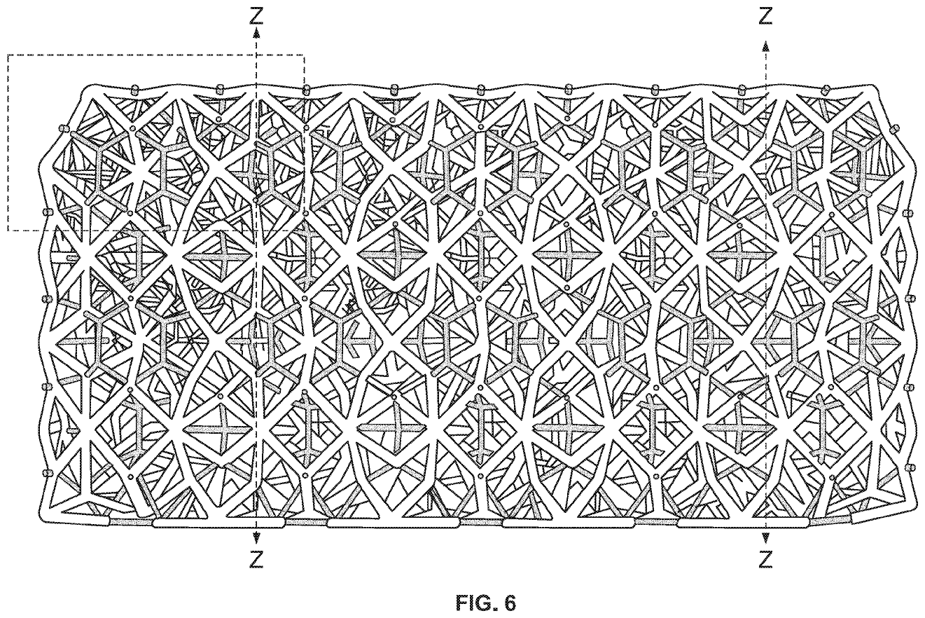

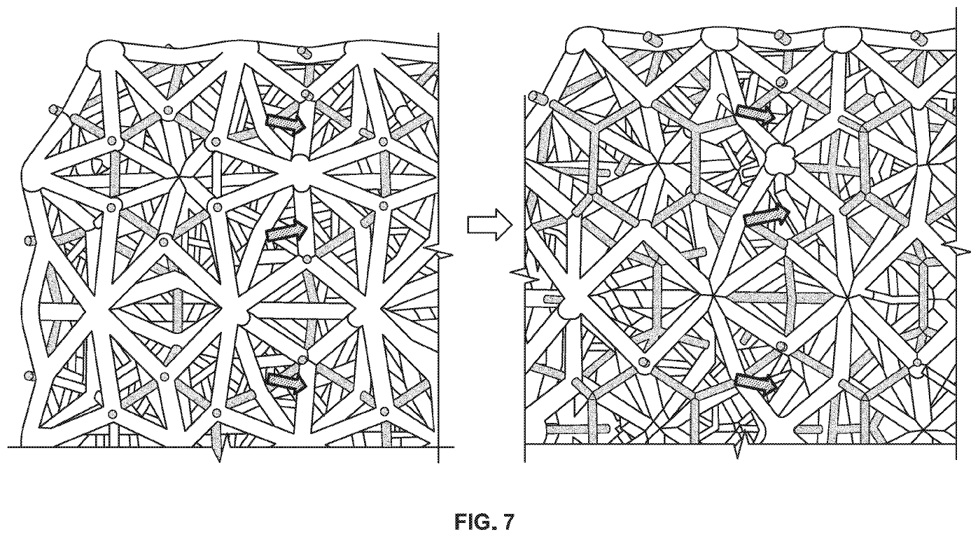

In operation 106, a final compound structure may be formed by modifying the initial compound structure so that struts within the initial compound structure that are substantially parallel and/or perpendicular to a predetermined energy absorbing load vector of the lattice structure are removed. The predetermined energy absorbing load vector is illustrated as the lines z-z in FIGS. 5B and 6. In some embodiments, removal of the struts of the initial compound structure may be tunable based on (a) strut diameter ratio and/or (b) rhombile subset selection. In some embodiments, removal of the struts may improve an energy absorbing quality of the lattice structure. In some embodiments, a stiffness of the first lattice substructure is sufficiently different from a stiffness of the second lattice substructure along the predetermined energy absorbing load vector, so that buckling of the first and second lattice substructures under a load applied to the final compound structure along the predetermined energy absorbing load vector occurs sequentially rather than concurrently, thereby enhancing the energy absorbing capacity of the final compound structure. FIG. 6 illustrates an example final compound lattice structure as produced by operation 106. FIG. 7 illustrates a comparison of the initial compound structure of operation 105 (e.g., the portion of FIG. 5B illustrated within the dashed box) with the final compound structure of operation 106 (e.g., the portion of FIG. 6 illustrated within the dashed box). Though the operations of FIG. 1A describe two lattice substructures, the present invention is not limited thereto. In some embodiments, three or more lattice substructures may be interwoven to form the final compound structure. In some embodiments, the final compound structure formed in operation 106 may be stored as a data representation of a three-dimensional object. In some embodiments, the geometry of the data representation may include a polysurface file (e.g., an .iges file) or a boundary representation (BREP) file (e.g., a .stl, .obj, .ply, .3mf, .amf or .mesh file). In some embodiments, the data representation may include an outline and/or data description of the object in three-dimensions suitable for manufacturing via an additive manufacturing process. In some embodiments, the final compound structure formed in operation 106 may be manufactured using an additive manufacture process (e.g., stereolithography).

According to some embodiments described herein, an energy absorbing lattice structure having a predetermined energy absorbing load vector, may include, in combination, a first lattice substructure comprised of a first set of interconnected struts, and, interwoven with said first lattice substructure, a second lattice substructure comprised of a second set of interconnected struts.

In some embodiments, said first lattice substructure and said second lattice substructure are interconnected with one another.

In some embodiments, the energy absorbing lattice structure is produced by a process of additive manufacturing (e.g., selective laser sintering (SLS), fused deposition modeling (FDM), stereolithography (SLA), three-dimensional printing (3DP), or multijet modeling (MJM)).

In some embodiments, said first and second lattice substructures are formed from the same material (e.g., a polymer, metal, ceramic, or composite thereof).

In some embodiments, said lattice structure is rigid, flexible, or elastic.

In some embodiments, said first set of interconnected struts and said second set of interconnected struts differ in diameter from one another. Optionally, said first set of interconnected struts comprises struts of differing diameters. Optionally, said second set of interconnected struts comprises struts of differing diameters.

In some embodiments, a stiffness of said first lattice substructure is sufficiently different from a stiffness of said second lattice substructure along said load vector, so that buckling of said substructures under a load applied to said structure along said load vector occurs sequentially rather than concurrently, thereby enhancing the energy absorbing capacity of said structure.

In some embodiments, struts that are substantially perpendicular to said load vector are excluded from said second lattice substructure.

In some embodiments, said first and second lattice substructures are defined by a tetrahedral mesh (e.g., an A15, C15, or alpha space packing, etc.) or a hexahedral mesh.

In some embodiments, said first set of interconnected struts interconnect centroids of adjacent tetrahedra of said mesh to one another, and said second set of interconnected struts interconnect a centroid of each tetrahedra of said mesh to four vertices thereof.

In some embodiments, said first set of interconnected struts interconnect the centroid of each tetrahedra of said mesh to the four vertices thereof, and said second set of interconnected struts interconnect the four vertices of each said tetrahedra of said mesh to one another.

In some embodiments, said first set of interconnected struts interconnect the centroids of adjacent tetrahedra of said mesh to one another, and said second set of interconnected struts interconnect the four vertices of each said tetrahedra of said mesh to one another.

In some embodiments, the energy absorbing lattice structure includes at least a third lattice substructure, interwoven with said first and second lattice substructures, and optionally interconnected with one or both thereof.

According to some embodiments described herein, a shock absorber, cushion, or pad includes a lattice structure of the embodiments described herein.

According to some embodiments described herein, a wearable protective device includes a cushion or pad of the embodiments described herein (e.g., a shin guard, knee pad, elbow pad, sports brassiere, bicycling shorts, backpack strap, backpack back, neck brace, chest protector, protective vest, protective jackets, slacks, suits, overalls, jumpsuit, and protective slacks, etc.).

According to some embodiments described herein, a bed or seat includes a cushion or pad of the embodiments described herein.

According to some embodiments described herein, an automotive or aerospace panel, bumper, or component includes a shock absorber, cushion, or pad of the embodiments described herein.

According to some embodiments described herein, a method of forming an energy absorbing lattice includes providing a mesh comprising a plurality of polyhedra, forming a first lattice substructure comprising a first set of interconnected struts that are defined by the mesh, forming a second lattice substructure including a second set of interconnected struts that are defined by the mesh, wherein the second lattice substructure differs from the first lattice substructure, and generating a compound lattice structure by combining the first lattice substructure with the second lattice substructure.

In some embodiments, the energy absorbing lattice includes a predetermined energy absorbing load vector, and the method further includes removing one or more struts from the compound lattice structure that are substantially perpendicular to the predetermined energy absorbing load vector.

In some embodiments, the method further includes manufacturing the compound lattice structure using an additive manufacturing process.

In some embodiments, forming the first lattice substructure includes forming a dual substructure by connecting centroids of adjacent polyhedra of the mesh.

In some embodiments, forming the second lattice substructure includes forming a rhombile tessellation substructure by connecting a centroid of each polyhedron of the mesh to corners of the polyhedron.

In some embodiments, the first lattice substructure and the second lattice substructure are interconnected with one another.

In some embodiments, the first set of interconnected struts and said second set of interconnected struts differ in diameter from one another.

In some embodiments, the first set of interconnected struts includes struts of differing diameters.

In some embodiments, the second set of interconnected struts includes struts of differing diameters.

In some embodiments, the mesh includes a plurality of tetrahedra or a plurality of hexahedra.

In some embodiments, the mesh includes a plurality of tetrahedra configured in an A15, C15, or alpha space packing structure.

In some embodiments, the first set of interconnected struts interconnect centroids of adjacent tetrahedra of the mesh to one another, and the second set of interconnected struts interconnect a centroid of each tetrahedra of said mesh to four vertices thereof.

In some embodiments, the first set of interconnected struts interconnect the centroid of each tetrahedra of the mesh to the four vertices thereof, and the second set of interconnected struts interconnect the four vertices of each tetrahedra of the mesh to one another.

In some embodiments, the first set of interconnected struts interconnect the centroids of adjacent tetrahedra of the mesh to one another, and the second set of interconnected struts interconnect the four vertices of each tetrahedra of the mesh to one another.

The foregoing is illustrative of the present invention, and is not to be construed as limiting thereof. The invention is defined by the following claims, with equivalents of the claims to be included therein.

1. An energy absorbing lattice structure having a predetermined energy absorbing load vector, said lattice structure comprising, in combination:
(a) a first lattice substructure comprised of a first set of interconnected struts; and
(b) a second lattice substructure interwoven with said first lattice substructure, the second lattice substructure comprised of a second set of interconnected struts,
wherein struts that are substantially perpendicular to the predetermined energy absorbing load vector are excluded from said second lattice substructure, and/or wherein struts that are substantially parallel to the predetermined energy absorbing load vector are excluded from said second lattice substructure.

2. The lattice structure of claim 1, wherein said first lattice substructure and said second lattice substructure are interconnected with one another.

3. The lattice structure of claim 1 produced by a process of additive manufacturing.

4. The lattice structure of claim 1, wherein said first and second lattice substructures are formed from the same material.

5. (canceled)

6. The lattice structure of claim 1, wherein
said first set of interconnected struts and said second set of interconnected struts differ in diameter from one another;
optionally, said first set of interconnected struts comprises struts of differing diameters; and
optionally, said second set of interconnected struts comprises struts of differing diameters.

7. The lattice structure of claim 1, wherein a stiffness of said first lattice substructure is sufficiently different from a stiffness of said second lattice substructure along said predetermined energy absorbing load vector, so that buckling of said first and second lattice substructures under a load applied to said lattice structure along said predetermined energy absorbing load vector occurs sequentially rather than concurrently, thereby enhancing an energy absorbing capacity of said lattice structure.

8. The lattice structure of claim 7, wherein the struts that are substantially perpendicular to said predetermined energy absorbing load vector are excluded from said second lattice substructure.

9. The lattice structure of claim 1, wherein said first and second lattice substructures are defined by a tetrahedral mesh or a hexahedral mesh.

10. The lattice structure of claim 9, wherein said first and second lattice substructures are defined by the tetrahedral mesh, and
wherein:
(a) said first set of interconnected struts interconnect centroids of adjacent tetrahedra of said tetrahedral mesh to one another; and
(b) said second set of interconnected struts interconnect a centroid of each tetrahedron of said tetrahedral mesh to four vertices thereof.

11. The lattice structure of claim 10, wherein:
(a) said first set of interconnected struts interconnect the centroid of each tetrahedron of said tetrahedral mesh to the four vertices thereof; and
(b) said second set of interconnected struts interconnect the four vertices of each said tetrahedron of said tetrahedral mesh to one another.

12. The lattice structure of claim 10, wherein:
(a) said first set of interconnected struts interconnect the centroids of adjacent tetrahedra of said tetrahedral mesh to one another; and
(b) said second set of interconnected struts interconnect the four vertices of each said tetrahedron of said tetrahedral mesh to one another.

13. The lattice structure of claim 1, further comprising:
(a) at least a third lattice substructure, interwoven with said first and second lattice substructures, and optionally interconnected with one or both thereof.

14. A shock absorber, cushion, or pad comprised of t lattice structure of claim 1.

15. A wearable protective device, bed, seat, automotive or aerospace panel, bumper, or component comprising the shock absorber, cushion, or pad of claim 14.

16-17. (canceled)

18. A method of forming an energy absorbing lattice having a predetermined energy absorbing load vector comprising:
providing a mesh comprising a plurality of polyhedra;
forming a first lattice substructure comprising a first set of interconnected struts that are defined by the mesh;
forming a second lattice substructure comprising a second set of interconnected struts that are defined by the mesh, wherein the second lattice substructure differs from the first lattice substructure;
generating a compound lattice structure by combining the first lattice substructure with the second lattice substructure; and
removing one or more struts from the compound lattice structure that are substantially perpendicular to the predetermined energy absorbing load vector, and/or that are substantially parallel to the predetermined energy absorbing load vector.

19. The method of claim 18, wherein the one or more struts that are removed from the compound lattice structure are substantially perpendicular to the predetermined energy absorbing load vector.

20. The method of claim 18, further comprising:
manufacturing the compound lattice structure using an additive manufacturing process.

21. The method of claim 18, wherein forming the first lattice substructure comprises forming a dual substructure by connecting centroids of adjacent polyhedra of the mesh.

22. The method of claim 18, wherein forming the second lattice substructure comprises forming a rhombile tessellation substructure by connecting a centroid of each polyhedron of the mesh to corners of the polyhedron.

23. The method of claim 18, wherein the first lattice substructure and the second lattice substructure are interconnected with one another.

24. The method of claim 18, wherein the first set of interconnected struts and the second set of interconnected struts differ in diameter from one another.

25. The method of claim 18, wherein the first set of interconnected struts comprises struts of differing diameters and/or the second set of interconnected struts comprises struts of differing diameters.

26. (canceled)

27. The method of claim 18, wherein the mesh comprises a plurality of tetrahedra or a plurality of hexahedra.

28. (canceled)

29. The method of claim 27, wherein the mesh comprises a plurality of tetrahedra configured in an A15, C15, or alpha space packing structure,
wherein the first set of interconnected struts interconnect centroids of adjacent tetrahedra of the mesh to one another, and
wherein the second set of interconnected struts interconnect a centroid of each tetrahedron of said mesh to four vertices thereof.

30. The method of claim 29, wherein the first set of interconnected struts interconnect the centroid of each tetrahedron of the mesh to the four vertices thereof, and
wherein the second set of interconnected struts interconnect the four vertices of each tetrahedron of the mesh to one another.

31. The method of claim 29, wherein the first set of interconnected struts interconnect the centroids of adjacent tetrahedra of the mesh to one another, and
wherein the second set of interconnected struts interconnect the four vertices of each tetrahedron of the mesh to one another.
